(19) United States
(12) Patent Application Publication
(10) Pub. No.: US 2022/0309432 A1
(43) Pub. Date: Sep. 29, 2022

(54) SUPPLY CHAIN OPTIMIZED ORDER AGGREGATOR

(71) Applicant: VIAHART LLC, Wills Point, TX (US)

(72) Inventors: Mike Molson Hart, Houston, TX (US); Doris Lu, Houston, TX (US)

(21) Appl. No.: 17/704,441

(22) Filed: Mar. 25, 2022

Related U.S. Application Data
(60) Provisional application No. 63/165,954, filed on Mar. 25, 2021.

(51) Int. Cl. G06Q 10/06; G06Q 30/06

(52) U.S. Cl. CPC G06Q 10/06315; G06Q 30/0635; G06Q 30/0641

(57) ABSTRACT

A method and process according to this disclosure provides for marketing and distributing a product prior to ordering any product from a supplier to reduce waste, conserve resources and reduce carbon emissions generated by transportation of products. The disclosed system and method provides for the conservation of resources that minimization of impact on the environment.

### CROSS REFERENCE TO RELATED APPLICATION

This application claims priority to U.S. Provisional Application No. 63/165,954 filed on Mar. 25, 2021.

### TECHNICAL FIELD

This disclosure is directed toward a system and method of marketing and distributing products based on a set of predefined thresholds to automate advantageous efficiencies of scale that reduces waste and conserves resources.

### BACKGROUND

Commerce has benefited from improvements in technology to expand the marketplace for customers, producers and distributors. However, even with such advances, commerce is still conducted according to common practices that have been around for generations.

Common practice is for a distributor to place an order for a product with a manufacturer and provide the manufacturer with a deposit to begin production. The distributor advances funds that can be significant and risks that the product may not sell. Once production is complete, the distributor inspects the product, takes delivery if satisfactory and pays the balance of the cost to the manufacturer. The goods are then shipped to a warehouse and stored until sold to individual purchasers. If the product is popular, all the product is sold. However, if the product is not popular, the distributor may be forced to accept a loss and the goods may be disposed of creating waste and possibly detrimentally affecting the environment. Moreover, expended costs in time, effort and shipping resources are wasted. Moreover, carbon emissions utilized to transport the products are unnecessarily emitted without providing a benefit.

Accordingly, it is desirable to develop new strategies for producing, and distributing products that increases production efficiencies, eliminates expensive storage costs, reduces and/or eliminates waste of resources, material, time, costs and reduces carbon emissions produced in shipping operations to reduce impact on the environment.

### SUMMARY

A system for automatically distributing products according to a disclosed example embodiment includes, among other possible things, a controller including a memory and a processor coupled to the memory programmed with executable instructions, the instructions including a distributor interface for receiving distributor and information, wherein the product information includes, but is not limited to, product description, origin location information, distribution region information, minimum threshold number of products for distribution, distribution time limit information, estimated shipping price information, and base price information.

The system further includes instructions to provide a communication component that automatically generates a graphic display for viewing information on the product by potential buyers of the product, the communication component including the product information from the distributor interface that is accessible to a buyer through a website. The communication component is further configured to display the minimum threshold number of products for distribution before any orders are fulfilled, a buyer interface including a portion enabling a buyer to indicate a desire to purchase a product, the buyer interface further configured to automatically generate a purchase agreement between a buyer and the distributor. The buyer interface is further configured to enable a buyer to indicate acceptance of the terms of the purchase agreement and to obtain and store buyer specific payment and location information. An order fulfillment component is also provided for automatically determining routing for all ordered products after the minimum threshold number of products have been ordered.

The system further includes a printing device in communication with the controller to automatically generate shipping labels in response to instructions from the controller indicating that the threshold number of products have been ordered, wherein the printing device automatically generates shipping labels for application to each ordered product for each individual buyer based on the determined shipping route.

A method of marketing and distributing products according to another disclosed example embodiment includes, among other possible things, receiving and storing product and distributor information. In one disclosed embodiment, the product information includes a product description, origin location information, distribution region information, minimum threshold number of products for distribution, distribution time limit information, estimated shipping price information, and base price information. The process further provides for automatically generating a graphic display with a processor using the stored product and distributor information for viewing information on the product by potential buyers of the product. The generated graphic display includes the product information from the distributor interface that is accessible to a buyer through a website. The method further provides a portion for affirming a buyer's desire to purchase a product with a buyer accessible interface. The buyer accessible interface automatically generates a purchase agreement between a buyer and the distributor in response to an indication that a buyer has affirmed a decision to purchase a product. One disclosed example buyer interface is further configured to enable a buyer to indicate acceptance of the terms of the purchase agreement and to obtain and store buyer specific payment and location information. The process further includes automatic determination of routing for all ordered products once the processor sends a signal indicating that the minimum threshold number of products have been ordered. Once the minimum number of orders has been received, the process automatically generates shipping labels with a printing device in response to instructions from the processor indicating that the threshold number of products have been ordered. The printing device automatically generates shipping labels for application to each ordered product for each individual buyer based on the determined shipping route.

Although the different examples have the specific components shown in the illustrations, embodiments of this disclosure are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWINGS

FIG. 1 flow diagram of an example system and method for automatically marketing and distributing goods.

FIG. 2 is a schematic view of the example system for automatically distributing goods.

FIG. 3 is a schematic graphic display for viewing and ordering a product according to one example embodiment.

FIG. 4 is a schematic illustration of one possible delivery routing through a selected shipping hub.

FIG. 5 is a schematic illustration of another possible delivery routing through another selected shipping hub.

### DETAILED DESCRIPTION

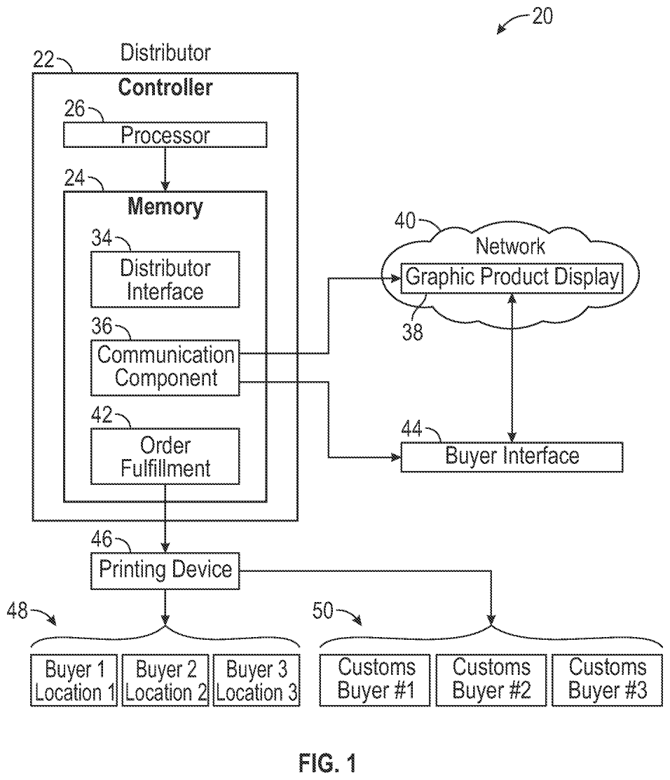

Referring to FIG. 1 an example marketing and distributing system is schematically shown and indicated at 20. A disclosed example marketing and distribution system 20 is utilized by a product distributor to reduce waste and maximize profits. Products are offered for sale, but not ordered or produced until a minimum number of products are sold. Buyers of the products are informed of a threshold number of product sales that are required before any orders are fulfilled. The distributor is able to sell at a reduced price because the risk of not selling an entire run of products is eliminated. Moreover, in one example embodiment, the threshold number of products that must be sold is tied to a cargo container. Additionally, the location of all the buyers for all the products in a cargo container is known prior to production. Accordingly, the shipping cost for the entire lot, from the distributor is known and is able to be effectively minimized before a single part is ordered, produced or distributed.

The Buyer is informed of the minimum threshold and obtains a reduced price in exchange for waiting until an entire lot is sold rather than immediately receiving a product.

Additionally, on a larger scale overall waste is reduced because products that are not desired are simply never manufactured or distributed. This saves material, labor and energy costs. Furthermore, the cost and energy associated with shipping is never wasted on shipping unwanted products.

In one disclosed example threshold quantity corresponds with a defined shipping unit. For example, if the product is 0.1 cubic meter (CBM) in freight volume and it fits tightly into a shipping container, which holds 67 CBM, the product threshold quantity may be set at 670 orders. In other words, none of the products will be ordered and/or produced until 670 orders are received so that the entire shipping container is filled, thereby eliminating any waste of space. In an alternative example embodiment, the threshold quantity could be selected based on the nature of the product. For example, a number of shirts may be cut from a standard roll of fabric. Thereby the number of shirts that can be produced from one standard roll would offer the best price per square yard of fabric and be used as the threshold quantity.

On a per unit basis the cost of shipping falls as the quantity of goods ordered rises, the greater the quantity of units purchased by a single buyer for parcel shipping, the cheaper the goods will be. This is achieved through not only cheaper shipping quotes for larger quantities, volumes, and weights of boxes and pallets of boxes offered by shipping companies, but also through packaging savings. Less labels and packaging material is needed on a per unit basis to ship more goods.

A box with two shoes takes up less space per shoe than a box with a single shoe. Accordingly, the threshold (which is based on the number of goods which fit tightly into a pallet, truckload, or shipping container) and intended order quantity can move up and down dynamically according to how many buyers order in multiples or singles. Moreover, different shipping companies perform differently and thereby can affect costs and customer satisfaction. Accordingly, the example system include supplier quality rankings that reflect different objective and subjective activities. For example, on-time delivery for each delivery company can be factored in automatically for each shipping decision. The supplier quality rankings may be generated by the distributor according to their own experiences and performance criteria. Moreover, the supplier ranking could be based on distributor preferences for a particular shipping company.

The example system is automated and implemented in one disclosed embodiment as software instructions prompting operation of the processor of a computer or controller 22. In one disclosed example embodiment, the processor 26 is programmed according to executable instructions stored in a memory device 24. The executable instructions stored in the memory device 24 includes instructions providing for a distributor interface 34, a communication component 36 and an order fulfillment component 42.

The example controller 22 may be a separate controller dedicated to the example system 20 may be software instructions executed as part of a computer system operated by a distributor. The example controller 22 relates to a device and system for performing necessary computing or calculation operations of the marketing and distribution system 20. The controller 22 may be specially constructed for operation of the system 20, or it may comprise at least a general-purpose computer selectively activated or reconfigured by software instructions stored in the memory device 24. The computing system can also consist of a network of (different) processors.

The memory device 24 provides for the storage of the software instructions that automatically prompts the various process and communication steps needed for marketing and distributing products. The software instructions may be embodied in a computer program that uses data input by a distributor and stored in the memory device 24 that may be required for its execution.

The instructions for executing operation of the example system 20 and the processor 26 are embodied in software instructions that may be stored on a computer readable medium. The computer readable medium may be embodied in structures such as, but is not limited to, any type of disk including floppy disks, optical disks, CD-ROMs, magnetic-optical disks, read-only memories (ROMs), random access memories (RAMS), EPROMs, EEPROMs, magnetic or optical cards, application specific integrated circuits (ASICs), or any type of media suitable for storing electronic instructions, and each coupled to a computer system bus. The disclosed computer readable medium may be a non-transitory medium such as those examples provided.

Moreover, the software instructions may be saved in the memory device 24. The disclosed memory device 24, may can include any one or combination of volatile memory elements (e.g., random access memory (RAM, such as DRAM, SRAM, SDRAM, VRAM, etc.) and/or nonvolatile memory elements (e.g., ROM, hard drive, tape, CD-ROM, etc.). The software instructions in the memory device 24 may include one or more separate programs, each of which includes an ordered listing of executable instructions for implementing logical functions. The disclosed processor 26 is configured to execute the software instructions stored within the memory device 24, to communicate data to and from the memory device 24, and to generally control operations pursuant to the software. Software in memory, in whole or in part, is read by the processor 26, perhaps buffered within the processor, and then executed.

The system 20 is operated by a distributor to automatically generate a graphic product display, schematically shown at 38, that is viewable by a buyer through a network 40. As appreciated, the network 40 provides access to buyers through a website to enable ordering of a product.

In this example, the communications component 36 automatically generates the graphic product display 38 and provides a buyer interface 44. Buyers utilize the buyer interface 44 to view information regarding a product for sale to make a buying decision. The buyer interface 44 further provides for the automatic generation of purchase agreements and further provides for acceptance by the buyer. Additionally, the buyer interface 44 provides for obtaining buyer location and payment location that is used upon attaining the minimum threshold number of orders.

Communication between the distributor interface, 34, the communication component 36, the buyer interface and the order fulfillment component 42 is bidirectional as information from each element is accessible by all of the other components as needed to facilitate each sections' functions.

The system 20 further includes an order fulfillment component 36 that provides automatic determination of shipping routes once the threshold number of product orders is obtained. Once the minimum threshold number of products is obtained, the system 20 automatically generates labels 48 for each product and buyer location. The system 20 may also generate any other required shipping documents, such as, for example, documents required by a customs agency of the shipping location as is indicated at 50.

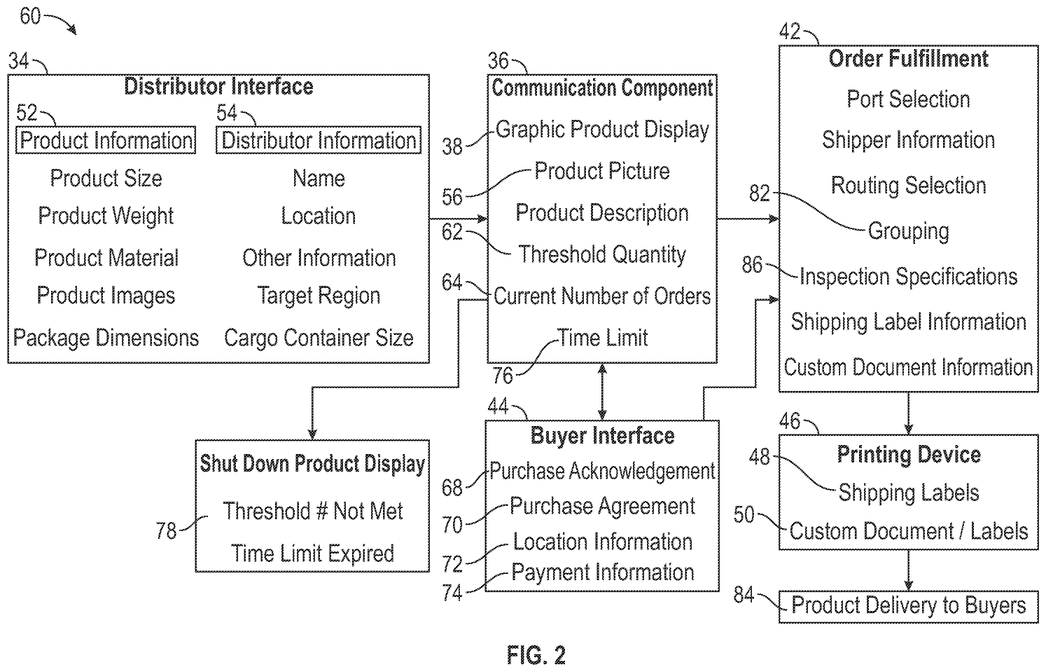

Referring to FIG. 2, a flow diagram of the example process executed by the system 20 and is generally indicated 60. One disclosed example embodiment is initiated by a distributor that would like to sell a product. Rather than order or produce the product prior to having sold the product, the distributor uses the example system 20 to obtain orders. The distributor begins the process by inputting product information as indicated at 52. The product information 52 can include size, weight, material, product images, packaging dimensions and any description desired to market and present the product to a buyer. Product information can include UPC codes and SKU#s that are associated with each product and variation. Moreover, some of the product information 52 is input to enable precise determination of cargo container capacity and thereby shipping costs.

The distributor interface 34 further includes a location for the input and saving of distributor information as indicated at 54. Distributor information 54 can include a location of the distributor and name. The location of the distributor in this example embodiment, is that location from which the products will be shipped. The origination of the product for shipping purposes enables a calculation of shipping costs. The distributor information can also include additional information that is not necessarily associated with the product or the distributor, but is needed to set costs and determined shipping costs. In this example, the distributor selects a target region for sales of the product and also selects the size of the cargo container. Both pieces of information are utilized later in the process 60 to determine precise shipping costs.

The size of the cargo container may include actual shipping containers, trailer capacities, dry van capacities along with the sizes that correspond to any means and mode for moving goods. The sizes of each of the containers are provided to distributors to enable logistical management of distribution.

One example cargo container that is utilized for shipping on a ship is known as a 20 foot general purpose (GP) container. The 20 foot GP container includes interior length of 19.35 feet by 7.72 feet wide by 7.85 feet high. Moreover, a 40 foot high cube (HC) container includes interior an interior length of 39.5 feet by 7.72 feet wide by 8.83 feet high. These interior dimensions are known and utilized to determine the threshold value as well as shipping costs. Another example shipping container is the interior size of a truck trailer is 52.5 feet long by 8.5 feet wide by 9.16 feet high. The trailer size is another example container size that can be utilized for determining the threshold value and shipping costs. As appreciated, various size cargo containers and shipping means may be utilized and are within the contemplation and scope of this disclosure.

The information input by the distributor is saved in a database for use at different stages of the process 60. It should be understood that the list of information can be expanded to include additional items that are used to facilitate marketing and distribution. For example, information regarding shipping services for different regions as well as information regarding requirements for meeting local regulations. The distributor interface may further include detailed information on other suppliers and vendors that aid in the production and distribution of products that are useful to the system.

Additionally, although marketing and shipment of a single product is disclosed by way of example, it is within the contemplation of this disclosure that multiple products and product families may be simultaneously entered and individually marketed and distributed. Moreover, several different products could be combined for shipping and minimum product order threshold level. Furthermore, many different distributors may use the example system and provide various different products. The different products may be combined to meet the desired threshold quantity to fill a defined cargo container. The combination of many different distributors and many different products provide an additional level of efficiency that can provide the benefits and efficiencies provided in this disclosure.

The communication component 36 provides for the automated generation of the graphic product display 38. The communication component 36 uses the product information to generate the product display.

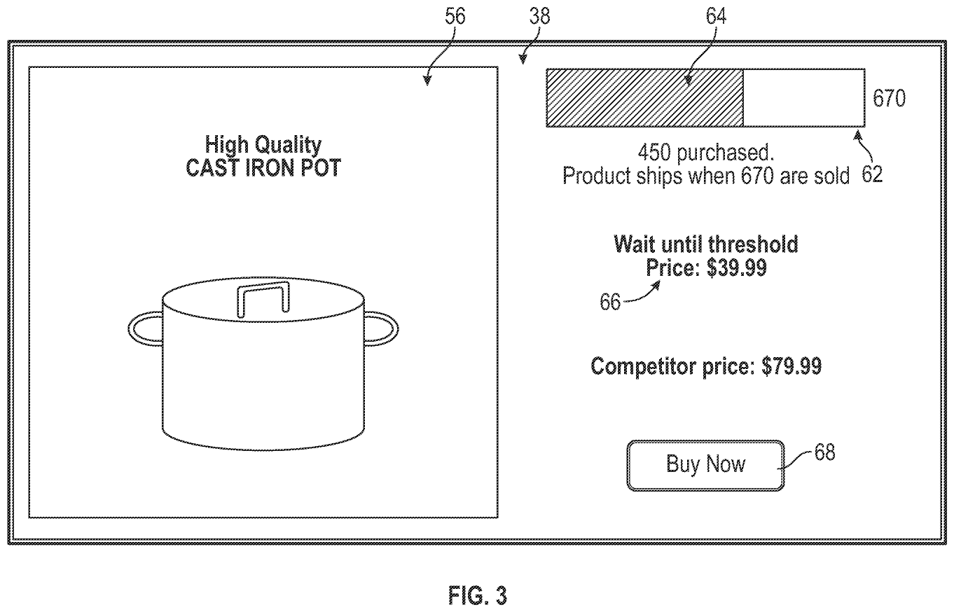

Referring to FIG. 3, with continued attention to FIG. 2, an example product display 38 for viewing by a buyer through the buyer interface is shown. The product display 38 includes an image 56, a base price 66 and a comparison to competitor pricing. The product display 38 further includes information regarding a minimum threshold number of products that must be sold before the purchase is completed and the product shipped as indicated at 62. The display 38 may include both graphic and text that indicate how many products have been ordered thus far as indicated at 64.

The provided information is all generated automatically by the system 20 based on information provided in the distributor interface 34 and a predefined template. By automatically generating the product display 38 according to a stored predefined template, the distributor can quickly begin gathering orders without agonizing over specific displays. It should be appreciated that many images 56 could be included as well as more detailed product description that correspond with the nature of the product. Moreover, the information provided can be tailored and focused to generate interest and encourage a buyer to purchase the product.

With the advent of the internet, e-commerce marketplaces are now actively used by most consumers. Accordingly, rather than selling goods directly, websites can mediate transactions between buyers and sellers on their website, providing value-added services such as verification and logistics to enable and lubricate purchasing transactions.

The graphic display 38 includes features that enable communication with the buyer interface 44 to facilitate purchase of the product. In this example, a “buy now” button 68 is provided that when selected opens a purchase page where the transaction can be completed.

The display 38 automates communication with the buyer interface 44 to complete the transaction and includes generation of a purchase agreement as indicated at 70 in FIG. 2. The purchase agreement 70 includes terms and conditions that facilitate the transaction and also commit the buyer to purchase of the product once the threshold value 62 is obtained. The purchase agreement 70 is automatically generated and includes terms that indicate the buyer's acknowledgement that the purchase will occur once the threshold number of orders have been obtained.

The posted price of the product 66 may be dynamically changed based on the number of products already sold. The price of the product 66 may further dynamically change based on preselected and defined criteria. For example, the price may be lowered for purchases of multiple products, delivery to commercial locations instead of residential locations, when a purchase is made relative to the time limit, payment methods, and or the location of the buyer relative to a shipping hub or origin of the product.

Additionally, the buyer interface 44 provides for the input and storage of buyer location and payment information as indicated at 72 and 74 in FIG. 2. The location information 72 is utilized later in the process 60 to determine shipping costs and to group products going to similar regions. The payment information 74 is stored until such time as the threshold quantity of orders is obtained.

The display 38 may set a time limit for attaining sufficient orders to meet the threshold sales quantity 62. The time limit, indicated at 76, is set by the distributor through the distributor interface 34. If the threshold quantity 62 is not reached by the time limit 76, the display 38 is taken down as indicated at 78. Once the display is taken down, the system 60 can send notes to those buyers that placed orders informing that the sale will not occur as defined according to the terms of the executed purchase agreement.

Referring back to FIG. 2, once the minimum threshold quantity is attained, the order fulfillment component 42 processes the orders. The fulfillment component 42 automatically begins determining shipping routing without any further action by the distributor. The system 20 automatically begins determining shipping costs to determine the most efficient and cost effective shipping routes.

Additionally, in another disclosed embodiment preparation and shipping of some orders can begin prior to the threshold number of orders being attained. Such a preliminary preparation and shipping can be utilized for products that have a sales history that supports beginning preparation short of the threshold orders. For example, if sales are being made at a constant, known rate, a prediction can be made as to when the threshold is reached and preparations for shipping can be initiated.

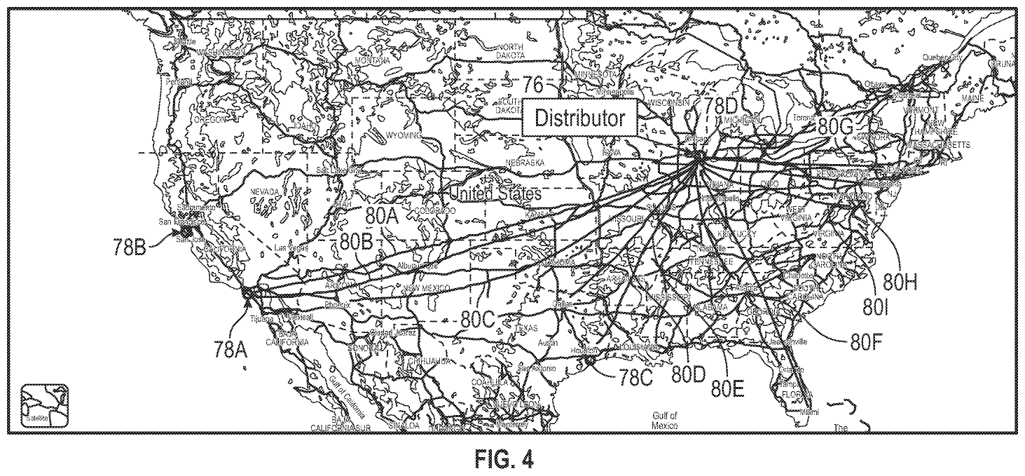

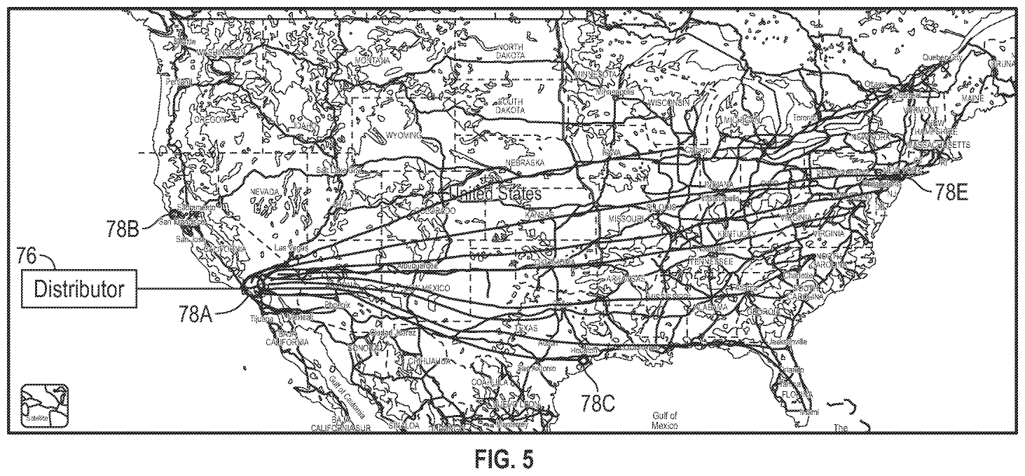

Referring to FIGS. 4 and 5, with continued reference to FIG. 2, the shipping route for each product to each buyer can be determined with the information provided by the buyer during the purchase process. The example maps show shipping routes from various shipping hubs.

However, not one, but all of the shipping routes can be determined at the same time because each buyer has included location information and all of the orders are shipped at the same time. This enables a determination of the aggregate shipping costs at one time. In other conventional web based purchase systems, each purchase is separate and is affected by the current shipping costs. Such costs may vary from week to week, or even from day to day. Accordingly, there is no way that the shipping costs for a product run can be determined when each order is processed and shipped separately.

Accordingly, with the location information of all of the buyers from a single point of distribution, a determination can be made as to what is the most cost efficient means of shipping all of the products for a set day. In one disclosed example, shown in FIG. 4, a distributor location 76 is known based on the original information provided by the distributor in the distributor interface 34. Each buyer location is also known from the information obtained and saved through the buyer interface 44. With the information the order fulfillment component 42 automatically determines the most cost efficient shipping routes. The determination includes a comparison of shipments from each of a plurality of preselected shipping hubs 78A-E. The shipping hubs 78A-E is the entrance location into a region.

In this example, the region is the United States and the shipping hubs 78A-E are located at various locations around ports and airports. The system 20, through the order fulfillment component 42 determines costs for shipment through each of the hubs 78A-E. From each of the hubs 78A-E, routes 80A-I are calculated to the final destination of each buyer. With this information a total aggregate shipping costs is calculated for each possible hub 78A-E.

FIG. 5 illustrates another example shipping route from the same hub 78A with different locations for each of the buyers. The location of the buyers may be grouped together and thereby facilitate grouping of orders by location as indicated at 82 in FIG. 2. Accordingly, the order fulfillment component 42 automatically provides for grouping orders for packing in a cargo container by location such that similar buyer locations are grouped together.

The cost of shipping includes many different variables that can be considered separately or in the aggregate. For example, every shipment includes costs associated with local labor, fees, and availability of different shipping vendors. The example disclosed system can be configured to consider all of the cost in the aggregate or specifically outline and break out different costs for each location for selection by the distributor or automatically according to a predefined distributor defined criteria. It should be appreciated that shipping costs can include any number of variables that can be considered when determining costs, and any such variable are within the scope and contemplation of this disclosure.

In one disclosed example, the order fulfillment component 42 utilizes shipping application programming interfaces (API) to communicate with shipping vendors. The API provides for communication with a shipping vendor to direct shipping, track packages and confirm delivery.

Referring back to FIG. 2, the order fulfillment component 60 automatically generates shipping labels 48 once the preferred shipping route for all of the purchased products has been determined. Generation of the shipping labels 48 is provided by a printing device 46 that receives singles and instructions from the system 20. The information stored relating to each of the buyers and the distributor is put into a label for application to the product packaging. The labels are prepared in groups that correspond with grouping of the buyers by location.

The printing device 46 may also automatically generate any documentation 50 that is required to move the product through customs. Because the system 20 has information for each buyer, an individual customs document can be prepared and utilized rather than compiling a single customs document to cover all of the products in a container and that are distributed. This is only possible because all of the products are sold and directed to an actual buyer. In traditional product distribution systems, the buyer is not necessarily known and therefore the distributor or a local agent must coordinate shipment through customs. Such large quantities of products can prompt application of substantial fees that further add to a product cost. However, as each product is ordered to correspond with a single buyer, such costs are minimal or non-existent.

The product labels 48 and customs labels 50 are then attached to each individual product and the products delivered to the buyers as indicated at 84.

Accordingly, the disclosed system 20 and method provides for the efficient and automatic marketing and distribution of products in a manner that conserves materials and energy while maximizing profit.

The products sold do not need to be in inventory. The products can be made after the threshold is met. Depending on the length of production, production can begin at the threshold quantity before the threshold of orders is met because more orders will be accumulated as production continues. Similarly, if the products are stored in a faraway location, such as on another continent, the goods at the threshold quantity can be shipped before the threshold is met because while they are on the sea or on a train, more orders will accumulate, reaching the threshold.

Orders for the product can be prepaid and since reaching the threshold and procurement of the product will take some time, in the meantime, the prepayments can be invested to earn additional income.

When the threshold is met, the sellers of the product will have the address information of all buyers. This information will be printed on the shipping labels and applied to the packages, whether the customer ordered 1 unit, 5 cases of 1 unit, 1 case of 5 units, etc. Before shipping, an inspection will be done on the goods for quality and packaging accuracy. The inspection standards 86 are derived from the product information input by the distributor in the distributor interface 34.

The disclosed system and method can be used for both international and domestic procurement, it is particularly useful for international. All international goods require customs clearance. The United States has a “de minimis rule”. In other words, if the value of the goods is below some total, it can be imported with minimal headache and customs duties. Rather than importing a large quantity with a single consignee and importer of record, because orders are aggregated before import, the shipment can be split up into entries for each buyer, potentially saving tariff and import duties.

While the disclosed system and method is a tool for sellers to sell products, the disclosed system can be implemented and combined with many different sellers in a single website or other accessible marketplace platform where sellers and buyers eventually form a marketplace for commerce that advantageously provides for efficiencies of scale when combined to save both distributors and sellers money and time. Moreover, the disclosed system and method further provides significant conservation of resources that not only benefits the involved parties, but provides a benefit to the environment and society as a whole.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A system for automatically distributing products comprising:
a controller including a memory and a processor coupled to the memory programmed with executable instructions, the instructions including:
a distributor interface for receiving distributor and information, wherein the product information includes product description, origin location information, distribution region information, minimum threshold number of products for distribution, distribution time limit information, estimated shipping price information, and base price information;
a communication component automatically generating a graphic display for viewing information on the product by potential buyers of the product, the communication component including the product information from the distributor interface that is accessible to a buyer through a website, the communication component further configured to display the minimum threshold number of products for distribution before any orders are fulfilled;
a buyer interface including a portion enabling a buyer to indicate a desire to purchase a product, the buyer interface further configured to automatically generate a purchase agreement between a buyer and the distributor, wherein the buyer interface is further configured to enable a buyer to indicate acceptance of the terms of the purchase agreement and to obtain and store buyer specific payment and location information;
an order fulfillment component for automatically determining routing for all ordered products after the minimum threshold number of products have been ordered; and
a printing device in communication with the controller to automatically generate shipping labels in response to instructions from the controller indicating that the threshold number of products have been ordered, wherein the printing device automatically generates shipping labels for application to each ordered product for each individual buyer based on the determined shipping route.

2. The system as recited in claim 1, wherein the distributor interface is further configured to receive information on a size of a cargo container and the minimum threshold number of products for distribution is automatically determined based on the product information and the selected size of the cargo container.

3. The system as recited in claim 2, wherein the order fulfillment component is further configured to automatically determine shipping cost information for each of a plurality of possible shipping routes for each of the ordered products and select the shipping routes for each of the ordered products that minimizes overall cost.

4. The system as recited in claim 3, wherein the automatic determination includes determining shipping cost for shipment of the cargo container to each of a plurality of shipping hubs and shipment of each individual product from each of the plurality of shipping hubs to the location of each buyer.

5. The system as recited in claim 4, wherein the order fulfillment component is further configured to group orders for packing in the cargo container by location such that similar buyer locations are grouped together.

6. The system as recited in claim 4, wherein the communication component is configured to display the distribution time limit and automatically remove the graphic display upon expiration of the time limit in response orders for the product failing to meet the minimum threshold number of products.

7. The system as recited in claim 6, wherein the communication component is further configured to display a number of orders relative to the minimum threshold number of orders.

8. The system as recited in claim 6, wherein the printing device is further configured to automatically generate any customs documents for each of the ordered products based on the buyer location information.

9. The system as recited in claim 8, wherein the order fulfillment component is further configured to automatically generate specification for inspection of product prior to distribution.

10. The system as recited in claim 1, wherein the minimum threshold number of products comprises more than one different product.

11. The system as recited in claim 10, wherein the minimum threshold number of products comprises products from more than one distributor.

12. The system as recited in claim 11, wherein the distributor interface provides for input from one or many distributors.

13. The system as recited in claim 12, wherein a different graphic display is automatically generated for each product and each distributor.

14. A method of distributing products comprising:
receiving and storing product and distributor information, wherein the product information includes product description, origin location information, distribution region information, minimum threshold number of products for distribution, distribution time limit information, estimated shipping price information, and base price information;
automatically generating a graphic display with a processor using the stored product and distributor information for viewing information on the product by potential buyers of the product, the generated graphic display including the product information from the distributor interface that is accessible to a buyer through a website;
providing a portion for affirming a buyer's desire to purchase a product with a buyer accessible interface;
automatically generating a purchase agreement between a buyer and the distributor in response to an indication that a buyer has affirmed a decision to purchase a product, wherein the buyer interface is further configured to enable a buyer to indicate acceptance of the terms of the purchase agreement and to obtain and store buyer specific payment and location information;
automatically determining routing for all ordered products, by the processor sending a signal indicating that the minimum threshold number of products have been ordered; and
automatically generating shipping labels with a printing device in response to instructions from the processor indicating that the threshold number of products have been ordered, wherein the printing device automatically generates shipping labels for application to each ordered product for each individual buyer based on the determined shipping route.

15. The method as recited in claim 14, further comprising automatically determining the minimum threshold number of products for distribution based on the number of products that can fit within a selected cargo container.

16. The method as recited in claim 15, further comprising automatically determining shipping costs for each of a plurality of possible shipping routes for each of the ordered products and selecting the shipping routes for each of the ordered products that minimizes overall cost.

17. The method as recited in claim 16, wherein the automatic determination includes determining shipping cost for shipment of the cargo container to each of a plurality of shipping hubs and shipment of each individual product from each of the plurality of shipping hubs to the location of each buyer.

18. The method as recited in claim 17, further comprising automatically assigning a grouping of orders in the cargo container by location such that products for shipment to buyers of similar locations are grouped together.

19. The method as recited in claim 18, further comprising automatically removing the graphic display upon expiration of the time limit in response orders for the product failing to meet the minimum threshold number of products.

20. The method as recited in claim 18, further comprising automatically generating the graphic display to indicate a current number of orders relative to the minimum threshold number of orders.

21. The method as recited in claim 18, further comprising automatically generating any customs documents required for each of the ordered products based on the buyer location information.

22. The method as recited in claim 21, further comprising automatically generating a specification for inspection of product prior to distribution based on the stored product information.

23. The method as recited in claim 14, wherein the minimum number of threshold products for distribution comprises a combination of different products.

24. The method as recited in claim 23, wherein the minimum number of threshold products for distribution comprises a combination of products from different distributors.

25. A method of marketing and distributing goods comprising:
determining, by a processor, a threshold quantity of products for sale, wherein the threshold quantity of products is determined by a determination, by the processor, of a maximum number of products capable of fitting within a selected cargo container; and
automatically generating a graphic display with the processor using stored product and distributor information, the graphic display configured for viewing information regarding the product by potential buyers;
automatically determining routing for all ordered products, by the processor in response to a signal indicating that the minimum threshold number of products have been ordered; and
automatically generating shipping labels with a printing device in response to instructions from the processor indicating that the threshold number of products have been ordered, wherein the printing device automatically generates shipping labels for application to each ordered product for each individual buyer based on a determined shipping route.

26. The method as recited in claim 25, further comprising pricing the products based on shipping costs determined for all of the orders of products.
